(19) United States
(12) Patent Application Publication
(10) Pub. No.: US 2004/0259524 A1
(43) Pub. Date: Dec. 23, 2004

(54) Telematics unit life-cycle management using VDU functionality

(75) Inventors: Gary A. Watkins, Royal Oak, MI (US); Christopher L. Oesterling, Troy, MI (US); David W. Rockett, Lake Orion, MI (US); Steven P. Schwinke, Plymouth, MI (US)

Correspondence Address: General Motors Corporation, Legal Staff, Mail Code 482-C23-B21, 300 Renaissance Center, P.O. Box 300, Detroit, MI, 48265-3000, US

(73) Assignee: General Motors Corporation

(21) Appl. No.: 10/601,466

(22) Filed: Jun. 23, 2003

(51) Int. Cl. H04M 11/00

(52) U.S. Cl. 455/405; 455/411; 705/32; 340/309.16

(57) ABSTRACT

A system and method for managing a vehicle telematics device subscription service cycle is described. A method according to the invention includes associating a vehicle telematics device with a vehicle telematics subscription service, maintaining subscription service data at the vehicle telematics device, and deactivating the vehicle telematics device at the vehicle at the expiration of the subscription service based on the subscription service data. A computer readable medium is also provided. According to the invention, the computer readable medium describes computer readable code for associating a vehicle telematics device with a vehicle telematics subscription service, maintaining subscription service data at the vehicle telematics device, and deactivating the vehicle telematics device at the vehicle at the expiration of the subscription service based on the subscription service data.

### FIELD OF THE INVENTION

The invention relates to management of data transmission over a wireless communication system. More specifically, the invention relates to a method and system for managing a vehicle telematics device subscription service cycle.

### BACKGROUND OF THE INVENTION

Many passenger vehicles now incorporate an integrated communication system. A Vehicle Communication Unit (VCU) used in conjunction with a Wide Area Network (WAN) such as a cellular telephone network or a satellite communication system allows for a variety of fee-based subscription services to be provided in a mobile environment. The VCU is typically a vehicle telematics device including a cellular radio, satellite transceiver and/or global positioning capabilities. Communication through a carrier service may be initiated at the VCU at turn-on or through manual or voice command phone number entry. Typically, a radio communication link is established between the VCU and a Wide Area Network (WAN), using a node of the WAN in the vicinity of the VCU.

In cellular telephone systems, a node is commonly referred to as a “cellular base station.” Once the radio communication link between the VCU and the cellular base station has been established, the base station then utilizes a combination of additional cellular base stations, land line networks, and possibly satellite systems to connect the VCU to the dialed telephone number.

A VCU must be initialized and configured for use with a cellular or satellite network. Different carrier services may use different communication protocols, and each individual VCU must be registered in the carrier system with a unique identification number that must also be authenticated to prevent fraudulent use of the VCU ID. Generally, a VCU is provided with a unique device identification number at manufacture (ESN.) A network identification number for use with a specific carrier is typically provided at the time of registration or activation with the carrier service. During a VCU activation process, the VCU must communicate with the cellular carrier to provide an authentication of the unique identification provided by the carrier to assure that the identification is associated with the correct VCU as indicated by the ESN. Typically, a service provider initiates a communication to the VCU to activate the unit. However, a VCU may not be within range of a configured service provider and a delay in authentication may occur, preventing customer use of the VCU.

After authentication, the VCU unit requires that cellular carrier information and user-specific subscription service data be periodically updated. For example, VCU subscription service providers generally employ multiple carrier companies having different coverage areas and protocols. If a vehicle owner with a subscription service permanently removes a VCU-equipped vehicle from the service range of the carrier configured for the VCU, then the VCU typically must be re-configured for a new carrier. In addition, subscription service data must be kept current at the VCU for services such as purchased airtime, or selected options for voice recognition and GPS services, for example. Finally, a VCU must be deactivated at the termination of a subscription cycle, in order to reduce the number of inactive VCUs in the service provider's system. Expired VCU units that are not properly deactivated present a drain on carrier system resources, and also reduce the number of VCU ID numbers and/or telephone numbers that might otherwise be recycled for new customers.

It would be desirable, therefore, to provide a method and system for managing a vehicle telematics device subscription service cycle at a vehicle telematics device that would overcome these and other disadvantages.

### SUMMARY OF THE INVENTION

The present invention is directed to a system and method for managing a vehicle telematics device subscription service cycle at a vehicle telematics device. A method according to the invention includes associating a vehicle telematics device with a vehicle telematics subscription service, maintaining subscription service data at the vehicle telematics device, and deactivating the vehicle telematics device at the vehicle at the expiration of the subscription service based on the subscription service data.

In accordance with another aspect of the invention, a system for managing a vehicle telematics device subscription service cycle at a vehicle telematics device is provided. The system includes means for associating a vehicle telematics device with a vehicle telematics subscription service, means for maintaining subscription service data at the vehicle telematics device, and means for deactivating the vehicle telematics device at the vehicle at the expiration of the subscription service based on the subscription service data.

In accordance with yet another aspect of the invention, a computer readable medium is provided. The computer readable medium includes computer readable code for associating a vehicle telematics device with a vehicle telematics subscription service, maintaining subscription service data at the vehicle telematics device, and deactivating the vehicle telematics device at the vehicle at the expiration of the subscription service based on the subscription service data.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram illustrating an operating environment according to an embodiment of the present invention;

FIG. 2 is a block diagram illustrating a mobile vehicle telematics device to which the method of the invention may be applied; and

FIG. 3 is a flow diagram illustrating a process for managing a vehicle telematics device subscription service cycle at a vehicle telematics device in accordance with the present invention.

### DETAILED DESCRIPTION OF THE PRESENTLY PREFERRED EMBODIMENT

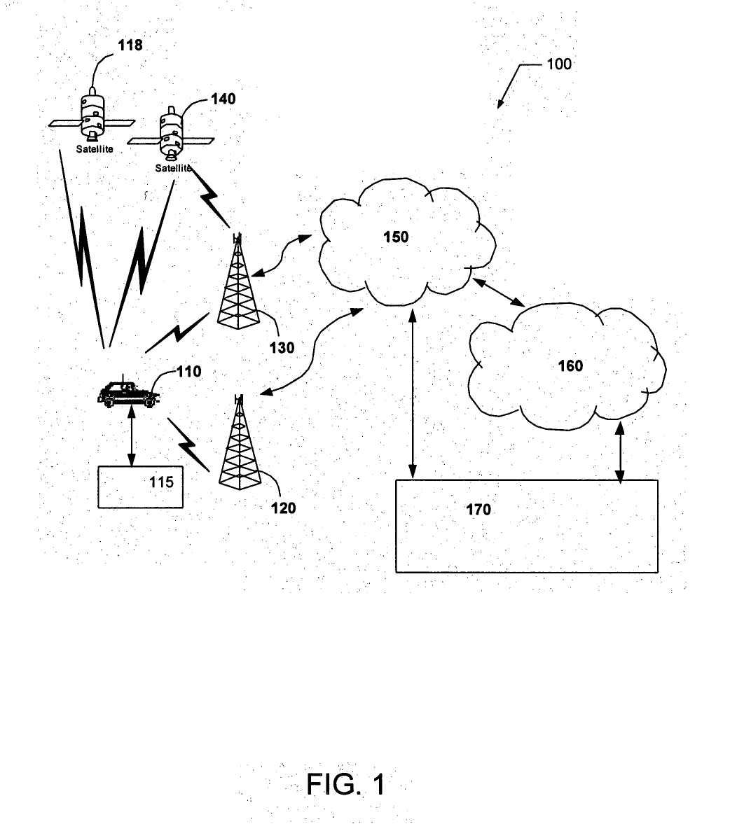

FIG. 1 is a block diagram illustrating an example of an operating environment according to an embodiment of the present invention. FIG. 1 shows an embodiment of a system for operating a satellite radio subscription service and a wireless communication service in a mobile vehicle, in accordance with the present invention, and may be referred to as a mobile vehicle communication system (MVCS) 100. The mobile vehicle communication system 100 may include one or more mobile vehicle communication units (MVCU) 110, one or more audio devices 115, one or more wireless communication systems 120, one or more radio carrier systems 130, one or more satellite broadcast systems 140, one or more communication networks 150, one or more land networks 160, and one or more service providers 170.

In one example, MVCS 100 is implemented as an OnStar system, as is known in the art, with regards to wireless communications, and as an XM Satellite Radio system, as is known in the art, with regards to satellite radio and terrestrial digital radio communications.

MVCU 110 includes a wireless vehicle communication device (module, MVCS module) such as an analog or digital phone with suitable hardware and software for transmitting and receiving data communications. In one embodiment, MVCU 110 further includes a wireless modem for transmitting and receiving data. In another embodiment, MVCU 110 includes a digital signal processor with software and additional hardware to enable communications with the mobile vehicle and to perform other routine and requested services.

In yet another embodiment, MVCU 110 includes a global positioning system (GPS) system 118 capable of determining synchronized time and a geophysical location of the mobile vehicle. GPS system 118 comprises a satellite that transmits signals to a unit (not shown) in the MVCU 110. In operation, MVCU 110 sends to and receives radio transmissions from wireless communication system 120. MVCU 110 may also be referred to as a mobile vehicle or a vehicle telematics device throughout the discussion below.

Audio device 115 includes hardware suitable for receiving broadcast signals within MVCU 110. In one embodiment, audio device 115 includes a receiver and receives broadcasts from wireless communication system 120, radio broadcast system 130, and satellite broadcast system 140.

In another embodiment, audio device 115 further includes a medium for storing programming information. In an example, the programming information includes customer requested programs supplied by one or more providers including various formats. Formatted programs may include “Talk Radio,” various music genres, targeted regional information, and the like. In another example, the customer requested programs are provided in the form of packages and referred to as a satellite radio program subscription (SRPS).

In yet another embodiment, audio device 115 further includes an audio speaker, a synthesized voice output, an audio channel, or the like. In an example, audio device 115 is implemented, in addition to the receiver, as a set of headphones, the audio portion of a television, a display device, or the like.

In another embodiment, MVCU 110 includes an automatic speech recognition system (ASR) module capable of communicating with audio device 115. In yet another embodiment, the module is capable of functioning as any part of or all of the above communication devices and, for another embodiment of the invention, may be capable of data storage, data retrieval, and receiving, processing, and transmitting data queries. In one example, audio device 115 includes an automatic speech recognition system (ASR) module.

Wireless communications system 120 is a wireless communications carrier or a mobile telephone system and transmits to and receives signals from one or more MVCU 110. Wireless communication system 120 incorporates any type of telecommunications in which electromagnetic waves carry signal over part of or the entire communication path. In one embodiment, wireless communication system 120 is implemented as any type of broadcast communication in addition to those of radio broadcast system 130 and satellite broadcast system 140. In another embodiment, wireless communications system 120 is implemented as a single unit in conjunction with radio broadcast system 130. In another embodiment, wireless communications system 120 is implemented via coupling with radio broadcast system 130, or in some such other configuration as would allow the systems to function as described.

In one example, such wireless communication carrier is a short message service, modeled after established protocols such as IS-637 SMS standards, IS-136 air interface standards for SMS, and GSM 03.40 and 09.02 standards. Similar to paging, an SMS communication could be broadcast to a number of regional recipients.

In another example, the mobile telephone system may be an analog mobile telephone system operating over a prescribed band nominally at 800 MHz. The mobile telephone system may be a digital mobile telephone system operating over a prescribed band nominally at 800 MHz, 900 MHz, 1900 MHz, or any suitable band capable of carrying mobile communications.

In another example, the mobile telephone system may be a digital mobile telephone system operating over Code Division Multiple Access (CDMA), TDMA (Time division multiple access) or GSM (global special mobile).

Radio broadcast system 130 transmits radio signals with data to audio device 115 within MVCU 110. In one embodiment, radio broadcast system 130 transmits analog audio and/or video signals. In an example, radio broadcast system 130 transmits analog audio and/or video signals such as those sent from AM and FM radio stations and transmitters, or digital audio signals in the S band (approved for use in the U.S.) and L band (used in Europe and Canada).

In another embodiment, audio device 115 stores or retrieves data and information from the audio and/or video signals of radio broadcast system 130. In an example, audio device 115 retrieves terrestrial digital radio signals from a signal received from radio broadcast system 130.

Satellite broadcast system 140 transmits radio signals to audio device 115 within MVCU 110. In one embodiment, satellite broadcast system 140 may broadcast over a spectrum in the “S” band (2.3 GHz) that has been allocated by the U.S. Federal Communications Commission (FCC) for nationwide broadcasting of satellite-based Digital Audio Radio Service (DARS). In an example, satellite broadcast system 140 may be implemented as XM Satellite Radio.

In operation, broadcast services provided by radio broadcast system 130 and satellite broadcast system 140 are received by audio device 115 located within MVCU 110. Broadcast services include various formatted programs based on a package subscription obtained by the user and managed by the audio device 115 and referred to above.

Communications network 150 is implemented as any suitable system or collection of systems for connecting wireless communications system 120 to at least one MVCU 110 or to a service provider 170. In one embodiment, communications network 150 includes a mobile switching center and provides services from one or more wireless communications companies.

Land network 160 connects communications network 150 to service provider 170. In one embodiment, land network 160 is implemented as a public-switched telephone network, a wired network, an optical network, a fiber network, another wireless network, or any combination thereof. In an example, land network 160 includes an Internet protocol (IP) network. In another embodiment, an MVCU 110 utilizes all or part of the wireless communications system 120, communications network 150, and land network 160.

In yet another embodiment, land network 160 connects one or more communications systems 120 to one another. In another embodiment, communication network 150 and land network 160 connect wireless communications system 120 to a communication node or service provider 170.

Service provider 170 is implemented as one or more locations where communications may be received or originate to facilitate functioning of the mobile vehicle communication system (MVCS) 100. Service provider 170 may contain any of the previously described functions.

In one embodiment, service provider 170 is implemented as a call center, as known in the art. In an example, the call center is implemented as a voice call center, providing verbal communications between an advisor in the call center and a subscriber in a mobile vehicle. In another example, the call center is implemented as a voice activated call center, providing verbal communications between an ASR unit and a subscriber in a mobile vehicle. In yet another example, the call center is implemented as a virtual call center, providing virtual communications between a virtual advisor and a user interface. The term “virtual” means any embodiment that is at least partially operable with software rather than human intervention. In another embodiment, the call center contains any of the previously described functions.

In an example, the call center is implemented to service an OnStar system. In another example, the call center is implemented to service an XM Satellite Radio system. In yet another example, the call center is implemented to service one or more of the above examples, or other services.

In operation, a service provider 170 utilizes one or more portions of the aforementioned communications network to communicate subscriber requested programming to audio device 115. The subscriber requested programming may then be accessed by audio device 115 utilizing one or more radio broadcast system 130 and satellite broadcast system 140 segments.

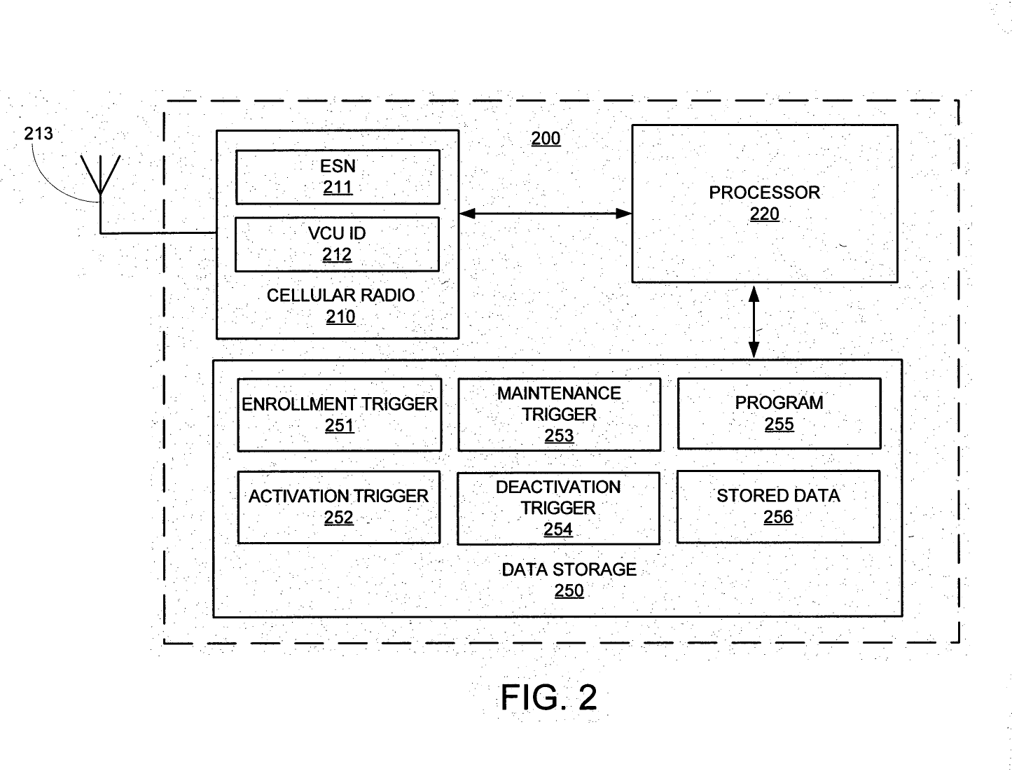

FIG. 2 is a block diagram illustrating a mobile vehicle telematics device to which the method of the invention may be applied. FIG. 2 shows an MVCU 200 comprising a cellular radio 210, a processor 220, and data storage 250. The cellular processor is shown further comprising an ESN 211 and a VCU ID 212. The cellular radio 210 is also shown coupled to an RF antenna 213. The data storage 250 is shown further comprising an enrollment event trigger 251, an activation event trigger 252, a maintenance event trigger 253, a deactivation event trigger 254, a program 255, and stored data 256. In FIG. 2, the cellular radio 210 is shown operably coupled to the processor 220. The processor 220 is shown operably coupled to the data storage 250. MVCU 200 may include additional components not illustrated that are not relevant to the present discussion.

The cellular radio 210 is any digital or analog radio device suitable for operation with a cellular network as described with reference to FIG. 1. The cellular radio 210 has an ESN 211 for telematics unit identification as is known in the art. The cellular radio 210 is, in one embodiment, configured for operation with a cellular carrier through an activation event. An activation event provides configuration data to the MVCU 200 to configure the cellular radio with the correct cellular carrier protocols. The cellular carrier registers the ESN 211 of the cellular radio 210, and receives a cellular system identification tag such as VCU ID 212, that is recognized in the carrier network. Typically, a telephone number is issued to the cellular radio 210 concurrent with activation.

The processor 220 is any processor, microcontroller or combination of processors and microcontrollers suitable for executing programs and managing data for MVCS 200. Processor 220 incorporates volatile or non-volatile memory (not shown) for storing or cacheing data and/or software modules.

The data storage 250 is any data storage device suitable for storing data, programs and/or software modules for use with MVCU 200. Data storage 250 provides storage for various data necessary for the operation of MVCU 200. In one embodiment, stored data 256 includes telematics device subscription service configuration data such as customer calling plan data, telematics device service provider data, telematics device authentication data and maintenance event data. In another embodiment, subscription service configuration data includes various event triggers. In yet another embodiment, various event triggers are stored onto data storage device 250 that specify a condition and an associated action to be initiated when the condition is satisfied. In one embodiment, an enrollment trigger 251 is stored onto data storage device 250 during the manufacture of the MVCU 200. The enrollment event trigger 251 includes, for example, a detectable trigger parameter such as a specific date, a specific odometer reading, or a specific count of ignition cycles.

In operation, the mobile vehicle telematics device is capable of transmitting and receiving signals and data, such as subscription service configuration data including various event triggers. The cellular radio 210 is configured to provide received data to the processor 220 for storage onto the data storage device 250. The event triggers stored in the data storage device 250 configure the MVCU 200 for initiating various routines, such as a vehicle data upload, based on the occurrence of an event trigger. In one embodiment, the occurrence of an enrollment event trigger 251 initiates a download of MVCU 200 configuration parameters, such as maintenance trigger parameters and activation trigger parameters. The activation trigger 252 comprises a determinable condition such as the completion of an enrollment event that, upon detection initiates an in-bound communication to a service provider for cellular radio 210 authentication.

The maintenance event trigger 253 comprises a trigger to initiate a periodic MVCU 200 update download. At least one program such as program 255 is configured to identify trigger events and, subject to the conditions of the detected trigger, initiate activity such as a vehicle data upload based on the identified event triggers. In one embodiment, program 255 is a vehicle data upload utility software module, as is known in the art. The application of a vehicle data upload utility in the present invention provides a method for automated subscription service management of a vehicle telematics device that is completely transparent to a user while in operation.

In the following process description, certain steps may be combined or occur in a different order without departing from the invention.

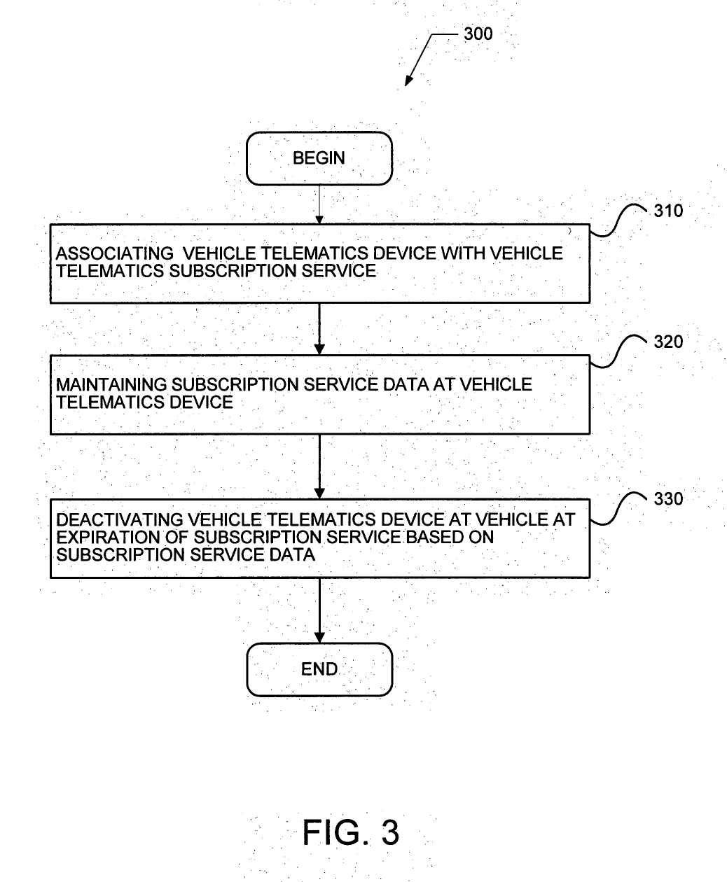

FIG. 3 is a flow diagram illustrating a method for managing a vehicle telematics device subscription service cycle at a vehicle telematics device in accordance with the present invention. The method 300 begins by associating a vehicle telematics device with a vehicle telematics subscription service (Block 310). The vehicle telematics device may be associated with a subscription service at any time after assembly of the vehicle telematics device. In one embodiment, the association cycle commences during the manufacture of a vehicle telematics device. In another embodiment, the association occurs after the installation of a new vehicle telematics device in an existing vehicle.

The vehicle telematics device for method 300 is an MVCU as illustrated in FIG. 2. The vehicle telematics subscription service is a fee-based service such as, for example, OnStar. In one embodiment, the association process begins with the programming of an enrollment event trigger 251 in the MVCU 200 at the time of manufacture of the MVCU 200. The enrollment trigger 251 provides a means of initiating an enrollment event. A program 255 is configured to monitor the vehicle telematics device to determine trigger events. Determining a trigger event comprises identifying a conditional event described by an event trigger defined by event trigger parameters, and initiating a specific predetermined action when the condition is satisfied. In one embodiment, the enrollment event comprises initiating and conducting a download of configuration parameters, such as maintenance trigger parameters and activation event trigger parameters to the MVCU 200. The enrollment event trigger 251 includes a detectable trigger parameter such as a specific date, a specific odometer reading, or a specific count of ignition cycles, for example. The trigger may also comprise the passing of a predetermined length of time, such as, for example, one or two months. The occurrence of any such event trigger invokes a control program to perform an enrollment event. In another embodiment, a user triggers an enrollment event by initiating a call to the service provider by depressing a service center calling button, such as is used with the OnStar system. Specific user data is required to complete an enrollment event, such as purchased airtime and billing data, for example. Such information may be provided at the time of vehicle purchase by a dealer through the Internet or other methods. In one embodiment, a parameter of an enrollment trigger requires that user data is available to the service provider and the vehicle telematics before an enrollment event is initiated. If user data is not available at the occurrence of another event trigger parameter, such as a specific date, then the enrollment event trigger parameter is reset to another date, and an event trigger detection program returns to monitoring for trigger events. The enrollment event will then occur when all required conditions of the enrollment event trigger are detected.

When the MVCU 200 initiates an enrollment event based on the occurrence of an enrollment event trigger parameter, an inbound communication is transmitted from the vehicle telematics device to the service provider. The service provider then provides a configuration data communication to the MVCU 200. The communication contains data such as telematics device subscription service data, activation event trigger parameters and maintenance trigger parameters. After receiving the data communication, a program 255 configures the MVCU 200 with activation event trigger parameters and maintenance event trigger parameters based on the received configuration data. The configuration data communication may additionally include telematics device configuration and subscription service data such as, for example, customer calling plan data, telematics device service provider data, telematics device authentication data and maintenance event data, which is stored to a data storage device 250.

After a successful configuration of the vehicle telematics device, an activation event trigger condition is met and the MVCU 200 is activated for operation with the subscription service. When the MVCU 200 initiates an activation event based on the occurrence of an activation event trigger parameter, an inbound communication is initiated to register an authentication key. An inbound call is generated outside a call center and transmitted into the call center. An outbound call originates in a call center and is transmitted out of the call center. After the MVCU 200 is authenticated, the MVCU 200 may be used with the service provider and the local cellular carrier for various subscription services. Authentication is well known to those skilled in the art. The vehicle data upload and activation event processes are automated actions that, according to the invention, are initiated by a program 255, and are transparent to a vehicle user.

After successful enrollment and activation of a vehicle in a vehicle telematics subscription service, accurate customer, carrier and MVCU 200 configuration data must be maintained at the MVCU 200 (Block 320). In one embodiment, when the MVCU 200 determines a maintenance event based on the occurrence of a maintenance trigger, an inbound communication is initiated from the vehicle telematics device to the service provider. The service provider then provides a maintenance data communication to the MVCU 200 having updated maintenance event trigger parameters. The updated maintenance event trigger parameters are then configured at the MVCU 200. In one embodiment, the maintenance event trigger parameters include parameters such as a predetermined number of vehicle ignition cycles, a predetermined number of expired months and a predetermined number of vehicle miles traveled. In another embodiment, the maintenance data communication includes telematics device configuration and subscription service data such as, for example, customer calling plan data, telematics device service provider data, telematics device authentication data and maintenance event data to be stored to a file or files, such as stored data 256.

Step 320 may occur at any time after activation of the MVCU 200. In one embodiment, a subscription service maintenance period causes step 320 to periodically repeat until a condition is met, including such parameters as a particular date, for example. In one embodiment, a program 255 continuously monitors MVCU 200 for the occurrence of maintenance event triggers until the expiration date of a subscription service. The subscription service expiration date is data that is typically included in a maintenance data communication from the service provider, so that changes to the subscription service are current at the MCVS 200. For example, if a user purchases a new subscription service plan or additional airtime prior to the expiration of an existing subscription, the service plan changes would be provided to the MVCU 200 in a maintenance data upload prior to a deactivation event. In one embodiment, loss of a detectable cellular carrier for a predetermined time period triggers a maintenance event. A vehicle that relocates to a region served by another carrier may be reconfigured with a maintenance event. In yet another embodiment, the maintenance event may incorporate a step 310 to reconfigure an MVCU 200 for a new cellular carrier.

The vehicle telematics device is deactivated at the vehicle at the expiration of the subscription service based on the subscription service data (Block 330). At the completion of a subscription service the MVCU 200 is disassociated with the subscription service. In one embodiment, a subscription service termination date is saved in stored data 256. In another embodiment, determining the expiration of the subscription service triggers the MVCU 200 to initiate an inbound communication to the service provider to confirm surrender of the associated telephone number and VCU ID 212 of the MVCU 200. In yet another embodiment, the MVCU 200 deactivates the cellular radio 210 at the expiration date of the subscription service. In still another embodiment, the MVCU 200 returns to step 320 to check for a new subscription service on a predetermined periodic basis.

The present invention may be embodied in other specific forms without departing from its spirit or essential characteristics. The described embodiments are to be considered in all respects only as illustrative and not restrictive.

We claim:

1. A method for managing a vehicle telematics device subscription service cycle at a vehicle telematics device comprising:
associating a vehicle telematics device with a vehicle telematics subscription service;
maintaining subscription service data at the vehicle telematics device; and
deactivating the vehicle telematics device at the vehicle at the expiration of the subscription service based on the subscription service data.

2. The method of claim 1 wherein associating a vehicle telematics device with a subscription service comprises:
configuring an enrollment event trigger parameter in the vehicle telematics device.

3. The method of claim 2 wherein the enrollment event trigger is selected from the group consisting of number of ignition cycles, expired months, specific date and miles traveled.

4. The method of claim 2 further comprising:
determining an enrollment event based on the enrollment event trigger parameter;
initiating an inbound communication from the vehicle telematics device responsive to a determination of an enrollment event;
receiving a configuration data communication; and
configuring an activation event trigger parameter and a maintenance event trigger parameter based on the received configuration data.

5. The method of claim 4 wherein the configuration data communication includes telematics device subscription service data selected from the group consisting of customer calling plan data, telematics device service provider data, telematics device authentication data and maintenance event data.

6. The method of claim 4 further comprising:
activating the vehicle telematics device for operation with the subscription service.

7. The method of claim 6 wherein activating the vehicle telematics device comprises:
determining an activation event based on the activation event trigger parameter;
initiating an inbound communication responsive to a determination of an activation event; and
registering an authentication key.

8. The method of claim 4 wherein maintaining subscription service data at the vehicle telematics unit comprises:
determining a maintenance event based on the maintenance event trigger parameter;
initiating an inbound communication responsive to a determination of a maintenance event;
receiving a maintenance data communication having an updated maintenance event trigger parameter; and
configuring an updated maintenance event trigger parameter at the vehicle telematics device.

9. The method of claim 1 wherein deactivating the vehicle telematics device comprises disassociating the vehicle telematics device from the vehicle telematics device subscription service.

10. A computer readable medium storing a computer program comprising:
computer readable code for associating a vehicle telematics device with a vehicle telematics device subscription service;
computer readable code for maintaining subscription service data at the vehicle telematics device; and
computer readable code for deactivating the vehicle telematics device at the vehicle at the expiration of the subscription service based on the subscription service data.

11. The computer readable medium of claim 10 wherein computer readable code for associating a vehicle telematics device with a subscription service comprises:
computer readable code for configuring an enrollment event trigger parameter in the vehicle telematics device.

12. The computer readable medium of claim 11 further comprising:
computer readable code for determining an enrollment event based on the enrollment event trigger parameter;
computer readable code for initiating an inbound communication from the vehicle telematics device responsive to a determination of an enrollment event; and
computer readable code for configuring an activation event trigger parameter and a maintenance event trigger parameter based on a received configuration data communication.

13. The computer readable code of claim 12 wherein the received configuration data includes vehicle telematics device subscription service data selected from the group consisting of customer calling plan data, vehicle telematics device service provider data, vehicle telematics device authentication data and vehicle telematics device maintenance event data.

14. The computer readable medium of claim of claim 12 further comprising:
computer readable code for activating the vehicle telematics device for operation with the vehicle telematics device subscription service.

15. The computer readable medium of claim 14 wherein computer readable code for activating the vehicle telematics device comprises:
computer readable code for determining an activation event based on the activation event trigger parameter; and
computer readable code for initiating an inbound communication responsive to a determination of an activation event to register an authentication key.

16. The computer readable medium of claim 12 wherein computer readable code for maintaining subscription service data at the vehicle telematics device comprises:
computer readable code for determining a maintenance event based on the maintenance event trigger parameter;
computer readable code for initiating an inbound communication responsive to a determination of a maintenance event; and
computer readable code for configuring an updated maintenance event trigger parameter at the vehicle telematics device based on a received maintenance data communication.

17. The computer readable medium of claim 10 wherein computer readable code for deactivating the vehicle telematics device comprises computer readable code for disassociating the vehicle telematics device from the vehicle telematics device subscription service.

18. A system for managing a vehicle telematics device subscription service cycle at a vehicle telematics device comprising:
means for associating a vehicle telematics device with a vehicle telematics subscription service;
means for maintaining subscription service data at the vehicle telematics device; and
means for deactivating the vehicle telematics device at the vehicle at the expiration of the subscription service based on the subscription service data.
